(19) United States
(12) Patent Application Publication
(10) Pub. No.: US 2016/0212048 A1
(43) Pub. Date: Jul. 21, 2016

(54) OPENFLOW SERVICE CHAIN DATA PACKET ROUTING USING TABLES

(71) Applicant: Hewlett Packard Enterprise Development LP, Houston, TX (US)

(72) Inventors: Gideon Kaempfer, Raanana (IL); Gal Mainzer, Herzelia (IL); Ariel Noy, Hertzliya (IL); Barak Perlman, Rehovot (IL)

(21) Appl. No.: 14/996,647

(22) Filed: Jan. 15, 2016

Related U.S. Application Data
(60) Provisional application No. 62/103,671, filed on Jan. 15, 2015.

(51) Int. Cl. H04L 12/741; H04L 12/931; H04L 12/721

(52) U.S. Cl. CPC H04L 45/745; H04L 45/72; H04L 49/35; H04L 45/54

(57) ABSTRACT

An OpenFlow switch routes a data packet to a next hop using tables. One or more direction tables are used to determine whether the packet is part of an upstream service chain, part of a downstream service chain, or is to be forwarded in a destination-based manner.

### RELATED APPLICATIONS

The present patent application claims priority to the provisional patent application filed on Jan. 15, 2015, and assigned patent application No. 62/103,671, which is incorporated herein by reference.

### BACKGROUND

A network is a collection of computing-oriented components that are interconnected by communication channels that permit the sharing of resources and information. Traditionally, networks have been physical networks, in which physical computing devices like computers are interconnected to one another through a series of physical network devices like physical switches, routers, hubs, and other types of physical network devices. More recently, virtual networks have become more popular.

Virtual networks permit virtual and/or physical devices to communicate with one another over communication channels that are virtualized onto actual physical communication channels. The virtual networks are separated from their underlying physical infrastructure, such as by using a series of virtual network devices like virtual switches, routers, hubs, and so on, which are virtual versions of their physical counterparts. A virtual overlay network is a type of virtual network that is built on top of an underlying physical network.

A virtual overlay network built on top of an underlying physical network may be a software-defined network through which communication occurs via a software-defined networking protocol (SDN). An example of an SDN protocol is the OpenFlow protocol maintained by the Open Networking Foundation of Palo Alto, Calif. A software-defined network using the OpenFlow protocol is known as an OpenFlow network.

### BRIEF DESCRIPTION OF THE DRAWINGS

FIG. 1 is a diagram of an example OpenFlow network architecture.

FIG. 2 is a diagram of example service chains of network functions (NFs) that can be realized within an OpenFlow network.

FIGS. 3A, 3B, 3C, and 3D are diagrams of example tables of an OpenFlow switch that can be used to determine a next hop of a data packet and route the data packet to the next hop.

FIGS. 4A and 4B are diagrams of the example tables of FIGS. 3A-3D in an overview manner.

FIG. 5 is a diagram of an example OpenFlow network including OpenFlow switches programmed with tables.

### DETAILED DESCRIPTION

As noted in the background, virtual networks permit devices to communicate with one another over communication channels that are virtualized onto actual physical communication channels, and which are separated from their underlying physical communication channels. Furthermore, OpenFlow networks have been increasingly employed to realize network function virtualization (NFV). NFV permits network operators to provide network services to their customers, or subscribers. Examples of network services include content filtering, caching, security and optimization services.

Furthermore, service function chaining is a mechanism that can utilize the OpenFlow protocol for providing services within an NFV environment. Service function chaining involves forwarding a data packet along a service chain path among different network function (NF) instances that together realize a desired network service. A given service chain path may be common to a number of subscribers. Each NF instance can be implemented by one or more different physical or virtual network devices that process or act upon incoming data packets before forwarding them. As such, an OpenFlow network can be employed to cause a data packet to traverse the NF instances of a service chain to provide a network service in relation to a subscriber to whom the data packet pertains.

However, implementing NFV in the context of OpenFlow networks has proven difficult. OpenFlow devices, such as OpenFlow switches, may have limited storage and processing capability. While in theory programming OpenFlow switches to achieve NFV is possible, in actuality it is difficult. A given OpenFlow network may be expected to process data packets numbering in the billions—or more—in a relatively short period of time, such as one second. Ensuring that the data packets are promptly processed in a subscriber-aware service function chain has proven to be a hurdle within the networking industry, and as such few if any OpenFlow networking solutions exist that provide for NFV.

Disclosed herein are techniques that provide for service function chaining within the context of an OpenFlow network in a way that ensures that large numbers of data packets can be efficiently processed. In general, a number of OpenFlow switches within an OpenFlow network are each programmed with tables to forward data packets to next hops in accordance with service chains. The traversal logic through the tables is such that each data packet is applied against a minimal number of the forwarding, or flow, tables. This, among other features of the techniques disclosed herein, ensures that data packet processing through a service chain is accomplished quickly and efficiently.

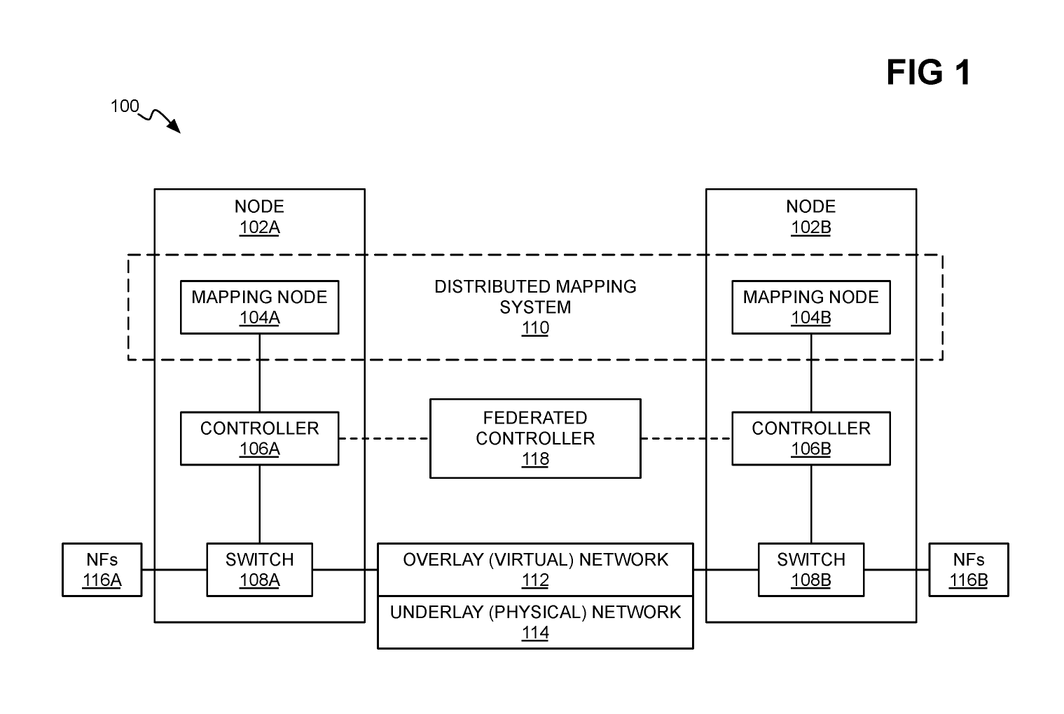

FIG. 1 shows an example OpenFlow network architecture 100. The network architecture 100 includes at least two distributed nodes 102A and 1026, collectively referred to as the nodes 102. The node 102A includes a mapping node 104A, an OpenFlow controller 106A, and an OpenFlow switch 108A. Likewise, the node 102B includes a mapping node 104B, an OpenFlow controller 106B, and an OpenFlow switch 108B. The mapping nodes 104A and 104B are collectively referred to as the mapping nodes 104; the OpenFlow controllers 106A and 106B are collectively referred to as the OpenFlow controllers 106; and the OpenFlow switches 108A and 1086 are collectively referred to as the OpenFlow switches 108.

The mapping nodes 104 form a distributed mapping system 110. The distributed mapping system 110 permits the OpenFlow controllers 106 to act together as one federated, or logical, controller 118. That is, the distributed mapping system 110 can be a database that indicates the functionality that each controller 106 is to provide its respective node 102 in a coordinated manner, so that the controllers 106 act in concert as the federated controller 118.

The OpenFlow controllers 106, based on the functionality indicated by their mapping nodes 104 of the distributed mapping system 110, correspondingly program, or control, their respective OpenFlow switches 108. The switches 108 are the components of the OpenFlow network architecture 100 that actually perform data packet forwarding, as programmed by the controllers 106. As such, the OpenFlow network is an SDN, because the OpenFlow switches 108 are realized in software running on virtual machines of hardware devices or running directly on hardware devices, such that the switches 108 can be programmed and reprogrammed as desired.

The OpenFlow switch 108A, on the same underlying hardware devices or on hardware devices to which the underlying devices are connected, can access network functions (NFs) 116A. Similarly, the OpenFlow switch 108B, on the same underlying hardware or on hardware devices to which the underlying devices are connected, can access or in effect realized NFs 116B. The NFs 116A and 1166 are collectively referred to as NFs 116.

Each NF 116 provides a function that can at least in part realize a network service, such that routing data packets among the NFs 116 in a particular order, or service chain, results in the data packets being subjected to desired network services. A given data packet may be forwarded among NFs 116 available at the same or different OpenFlow switches 108 to cause the data packet to be processed according to a desired service chain. The NFs 116 may be physical network functions (PNFs) performed directly on physical hardware devices, or virtual network functions (VNFs) performed on virtual machines (VMs) running on physical hardware devices.

The OpenFlow network itself is an overlay, or virtual, network 112, that is implemented on an underlying underlay network 114, which is depicted in FIG. 1 as being a physical network, but which can also be a virtual network. The overlay network 112 is implemented on the physical network 114 using tunneling to encapsulate data packets of the virtual overlay network 112 through the physical network 114. For instance, an overlay network data packet generated at a source node at the overlay network 112 and intended for a destination node at the overlay network 112 can be encapsulated within a tunneling data packet (i.e., a physical network data packet) that is transmitted through the underlay network 114. The virtual overlay network data packet is decapsulated from the tunneling data packet after such transmission for receipt by the destination node. Furthermore, the OpenFlow switches 108 can each have ports that connect to an outerlay network, which is a physical network connecting end points (as well as other networks) to the nodes 102. These ports can be referred to as outerlay ports.

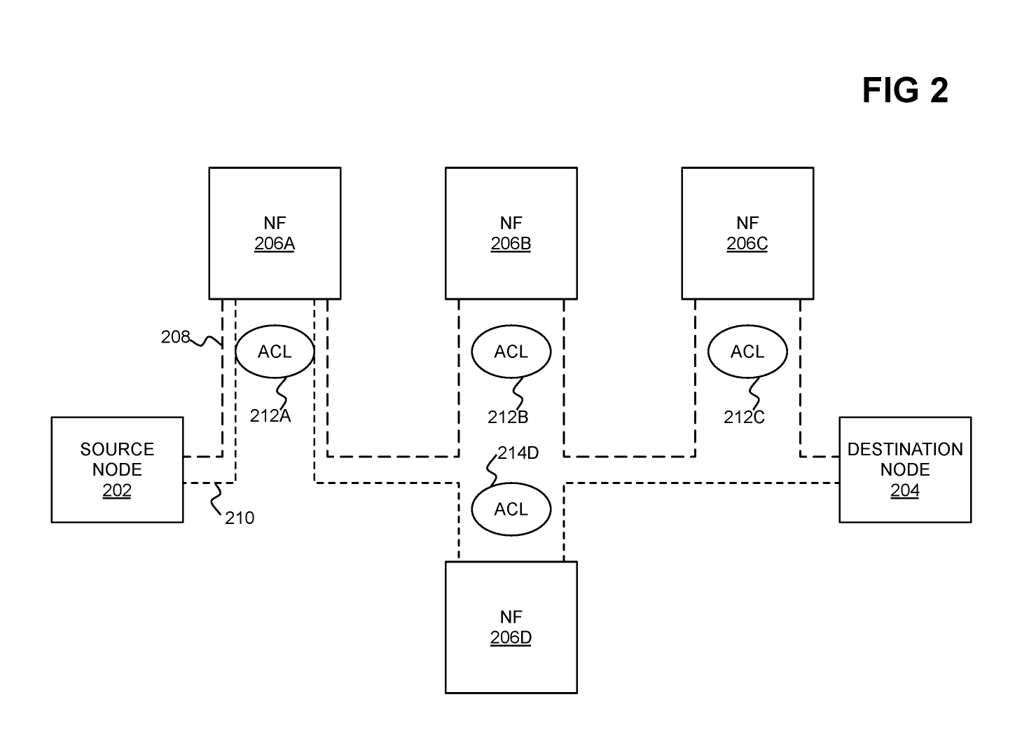

FIG. 2 shows example service chaining among NFs (particularly instances thereof), as a service definition. Data packets are transmitted from a source node 202 to a destination node 204 within an OpenFlow network like that of FIG. 1. Different NFs 206A, 206B, 206C, and 206D, collectively referred to as NFs 206, act on or process the data packets in different ways. One service chain 208 includes NFs 206A, 206B, and 206C, in that order, such that a data packet that is forwarded through the service chain 208 is first acted upon or processed by the NF 206A, followed by the NF 206B, and then by the NF 206C, in being transmitted from the source node 202 to the destination node 204. By comparison, another service chain 210 includes NFs 206A and 206D, in that order, such that a data packet that is forwarded through the service chain 210 is first acted upon or processed by the NF 206A before being acted upon or processed by the NF 206D in being transmitted from the source node 202 to the destination node 204. As such, the NF 206A is common to both service chains 208 and 210 in this example.

In one implementation, whether a data packet is to be acted upon by a particular NF 206 is controlled by a corresponding access control list (ACL) 212. That is, the NFs 206A, 206B, 206C, and 206D in this implementation include respective ACLs 212A, 212B, 212C, and 212D, which are collectively referred to as the ACLs 212. As a data packet advances from the source node 202 to the destination node 204, it is inspected against the ACLs 212 to determine if the corresponding NFs 206 should process or act upon the data packet. Each ACL 212 may be implemented as a white list, in which just the types of packets that are to be processed by the corresponding NF 206 are specified, or as a black list, in which just the types of packets that are not to be processed by the corresponding NF 206 are specified, or as a mixture of white and black lists. Which ACLs 212 to be applied is defined by the subscriber to which the network traffic in question belongs.

Therefore, as has been described in relation to FIGS. 1 and 2, the OpenFlow network of FIG. 1 provides for service chains of NFs, such as the service chains 208 and 210 of the NFs 206 of FIG. 2 via the OpenFlow switches 108, as programmed by the OpenFlow controllers 106 as coordinated by the mapping nodes 104 of the distributed mapping system 110. A data packet transmitted from the source node 202 to the destination node 204 may traverse either or both of the switches 108 over the overlay network 112, as dictated by the service chain 208 or 210 that applies to the data packet, and by where the NFs 206 of FIG. 2 are available (either as the NFs 116A at the switch 108A or as the NFs 1166 at the switch 108B). The switches 108 each employ multiple tables to quickly determine the next hop (e.g., the next NF) to which a data packet is to be forwarded within the overlay network 112 in accordance with a service chain.

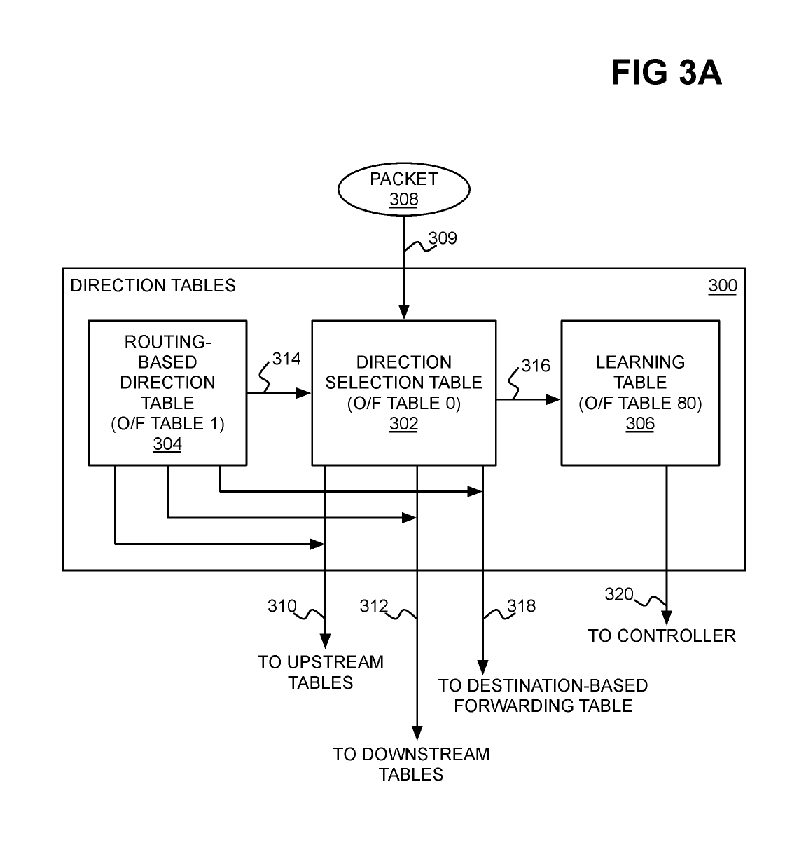

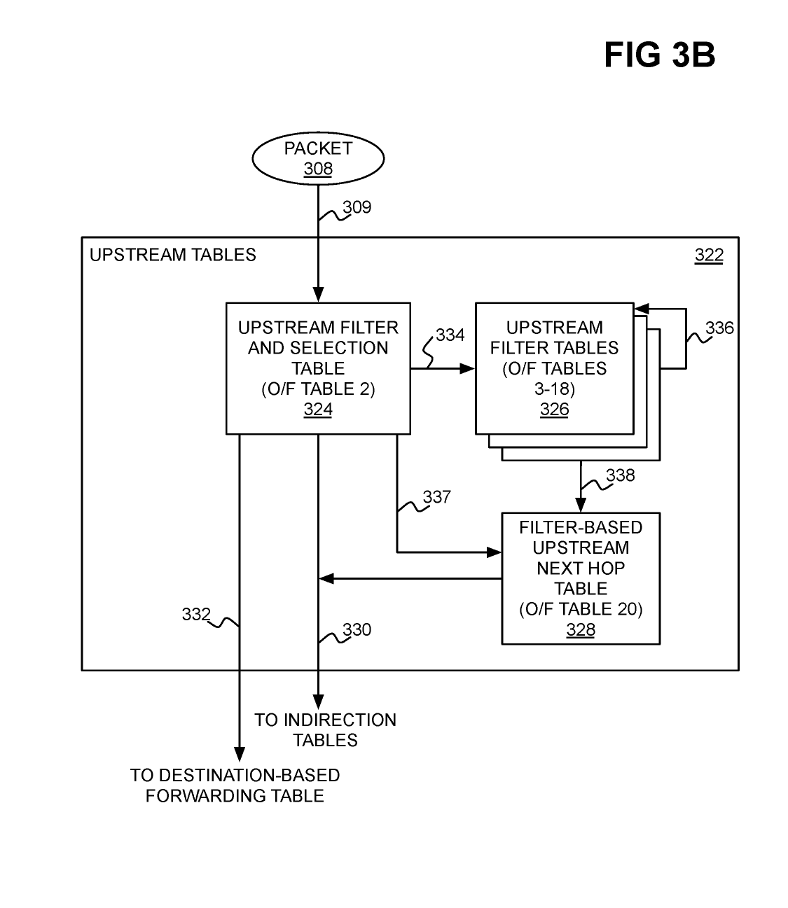

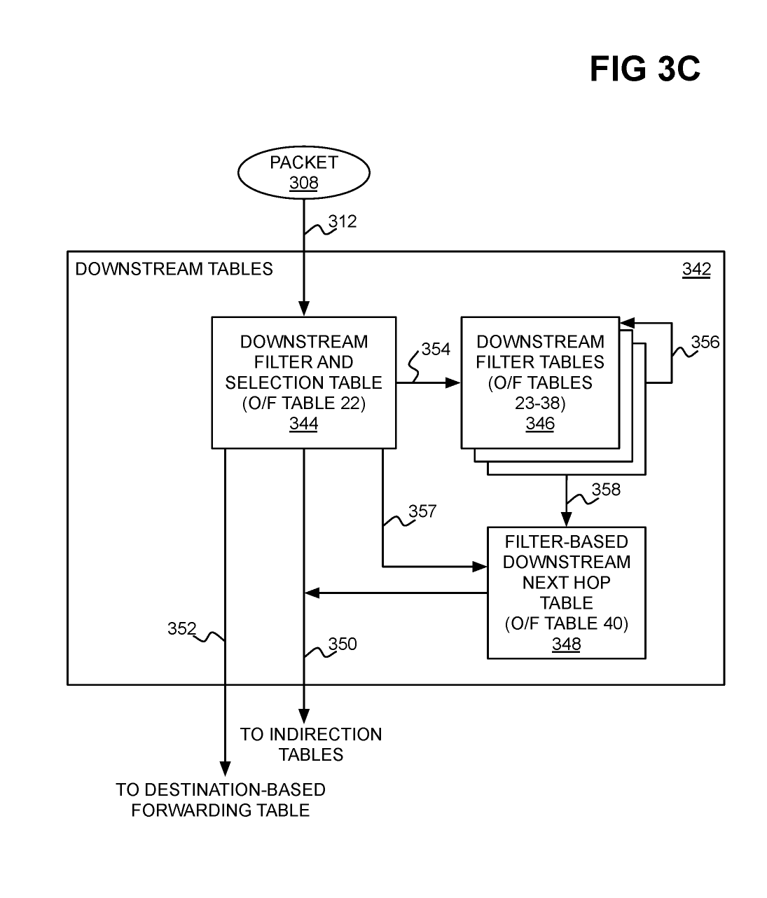

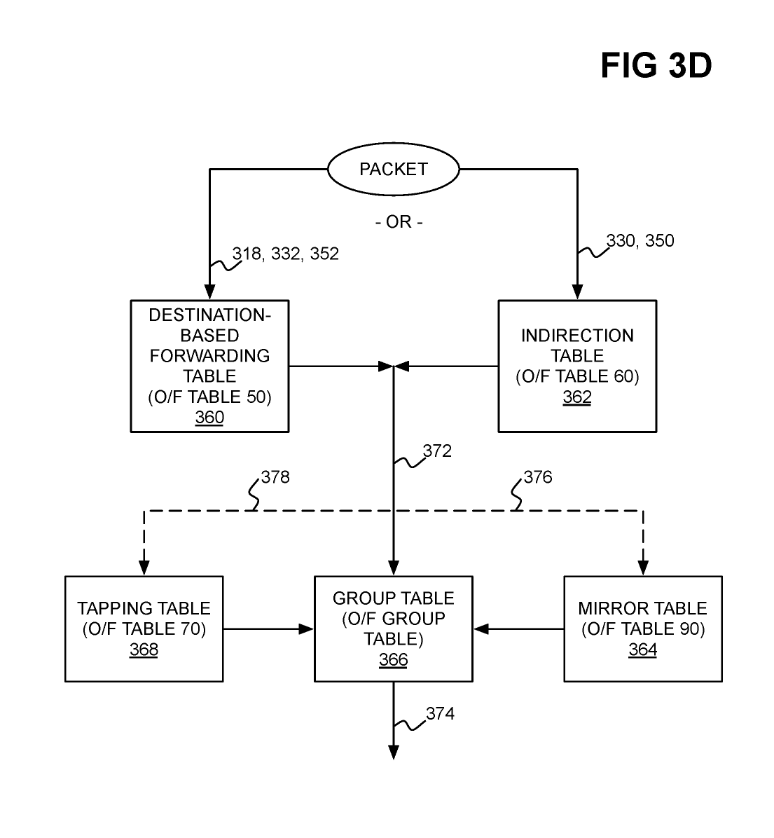

FIGS. 3A, 3B, 3C, and 3D show example tables that are programmed in and that are used by each OpenFlow switch 108 to forward or route data packets through the OpenFlow network. In general, OpenFlow tables are numbered from 0 through 255, and are programmed with rules. A rule of a given table in accordance with the OpenFlow protocol can only address another OpenFlow table with a higher number, by including a “goto” action. Within the OpenFlow protocol, the first table is table 0, and is the first table against which a data packet is to be applied.

FIG. 3A specifically shows example direction tables 300, including a direction selection table 302 (OpenFlow table 0), a routing-based direction table 304 (in one implementation, OpenFlow table 1), and a learning table 306 (in one implementation, OpenFlow table 80). An incoming data packet 308 is received at an outerlay port of the OpenFlow switch 108 in question. To determine the next hop, and thus the network function, to which the data packet 308 is to be forwarded or routed, the packet 308 is first applied against the direction tables 300 to determine whether the packet 308 is part of an upstream service chain, part of a downstream service chain, or is to be forwarded in a destination-based manner (as opposed to destination-indifferent forwarding such as service function chaining-based forwarding). For instance, upstream in this context may mean towards a wide-area network (WAN), whereas downstream may mean towards an access network, such as a radio access network (RAN).

Specifically, the data packet 308 is first received by the OpenFlow switch and applied against the direction selection table 302 to determine the next hop for the packet 308 (309). Two directions are defined: an upstream direction, associated with network traffic proceeding from an access network towards a core network, and a downstream direction, associated with network traffic proceeding from the core network towards the access network. Both the access network and the core network are connected to the outerlay network 112. The access network is the network of the subscriber devices, such as a mobile telephony network on which smartphone devices of subscribers are connected. The core network can be the Internet, for instance.

In one implementation, the direction selection table 302 is able to be employed if the packet 308 has a type indicating that the packet is an Internet Protocol (IP) packet. For example, the packet 308 may have an Ethertype that indicates that the packet is an IP packet. Therefore, if the packet 308 is an IP packet, the packet 308 is applied against the direction selection table 302 using at least a source address of the packet 308, such as a media access control (MAC) address of the packet. (In some implementations, in addition to the MAC address of the packet, other identifying information may be used, such as a virtual local-area network (VLAN) tag of the packet.)

There are at least three possibilities in applying the data packet 308 against the direction selection table 302. First, the MAC address may be successfully matched within the table 302, such that the source address of the packet 308 is known, and based on this successful match, the table 302 identifies that the packet is part of an upstream service chain or is part of a downstream service chain. In this case, the packet 308 is forwarded to upstream tables if it is part of an upstream service chain (310), or is forwarded to downstream tables if it is part of a downstream service chain (312).

Second, the MAC address may be successfully matched within the table 302, such that the source address of the packet 308 is known, but based on this successful match, the table 302 is unable to identify by the MAC address alone whether the packet is part of an upstream service chain or is part of a downstream service chain. In this case, the packet 308 is forwarded to the routing-based direction table 304 for further analysis (314). Third, the MAC address may not be successfully matched within the table 302, such that the source address of the packet 308 is unknown to the OpenFlow switch. In this case, the packet can be forwarded to the learning table 306 (316). Likewise, in one implementation, if the data packet 308 is an IPv6 packet of a particular type, such as a neighbor discovery packet, then the packet 308 is forwarded to the learning table 306 (316).

The data packet 308 is therefore applied against the routing-based direction table 304 to determine the next hop for the packet 308 if the packet 308 was matched within the direction selection table 302, but the table 302 was unable to identify whether the packet 308 is part of an upstream service chain or a downstream service chain. That is, the packet 308 is forwarded to the routing-based direction table 304 after the direction selection table 302 could not deduce the traffic flow direction of which the packet 308 is a part from just the source MAC address of the packet 308. The routing-based direction table 304 uses a part of the data packet 308 other than the source MAC address to determine whether the packet is part of an upstream service chain, a downstream service chain, or should be forwarded in a destination-based manner.

For example, the routing-based direction table 304 may match the IP address of the data packet 308 with one or more IP address subnets (i.e., bit-masked IP addresses). If a known subnet is identified, then the traffic direction associated with the subnet is established. Therefore, the packet 308 is forwarded to upstream tables if it is part of an upstream service chain (310), or is forwarded to downstream tables if it is part of a downstream service chain (312). In addition to or in lieu of IP address subnets, other information may be used by the routing-based direction table 304, such as virtual routing forwarding identification (VRFID) information set by the direction selection table 302. It is noted in this respect that matching of the VRFID information, both with and without an IP subnet, constitutes a logical partitioning of an OpenFlow table into multiple sub-tables, which permits the usage of a fixed number of tables while still allowing for different logical tables in different contexts.

As noted above, the next hop of the data packet 308 may be identified in a destination-based manner, such as based on the destination address of the packet 308 like the destination IP or the destination MAC address thereof. For instance, an NF instance may be classified by such a destination address. In such a case, the tables 302 and 304 may forward the data packet 308 to a destination-based forwarding table (318), which uses the destination address(es) of the packet 308 to determine the next hop.

If the direction selection table 302 forwards the data packet 308 to the learning table 306, the packet 308 is applied against the table 306 to determine the next hop for the packet 308. The learning table 306 acts as a filter for packets potentially destined towards the OpenFlow controller of the same node that includes the OpenFlow switch. Primarily, data packets are destined for the OpenFlow controller if they are packets related to address resolution protocol (ARP) or Internet control message protocol v6 (ICMPv6) neighbor discovery packets. Such routing permits the controller to learn the MAC addresses associated with these packets, and respond to them.

The learning table 306 may include one or more different rules. An Ethertype-based rule may be employed to match ARP packets to be sent to the controller, whereas an IPv6 next header-based rule may be employed to match particular ICMPv6 messages to the controller, such as neighbor discover protocol (NDP) and router advertisement (RA) messages. A default rule may further specify that all packets, or no packets, received by the table 306 be sent to the controller. Therefore, if application of the data packet 308 against the learning table 306 yields a match, the packet 308 is forwarded or routed to the OpenFlow controller (320).

It is noted that the architecture of the tables 300 is such that advantageously a minimum number of the tables 300 are applied against the data packet 308. In some situations, just the direction selection table 302 is applied against the packet 308. In other situations, at most just two of the direction tables 300 are applied against the data packet 308: the direction selection table 302 and either the routing-based direction table 304 or the learning table 306. This architecture helps ensure that packet processing quickly occurs within the OpenFlow switch of which the tables 300 are a part, permitting a greater number of packets to be processed by the switch in a minimum length of time.

FIG. 3B shows example upstream tables 322 that process the data packet 308 after the direction tables 300 of FIG. 3A have concluded that the packet 308 is part of an upstream service chain, per the arrow 310. The upstream tables 322 include an upstream filter and selection table 324 (in one implementation, OpenFlow table 2), multiple upstream filter tables 326 (in one implementation, OpenFlow tables 3-18), and an upstream next hop table 328 (in one implementation, OpenFlow table 20). In general, the packet 308 is applied against the upstream tables 322 such that the number of the tables 322 against which the packet 308 is applied is minimized, to determine the next hop of the packet 308. Further, the sizes of the tables 326 in particular, are relatively small when compared to the number of subscribers within a network, which assists in ensuring that the tables 326 can fit in OpenFlow switches that have relatively small amounts of memory, and further aids in updating the tables 326 quickly.

The data packet 308 is first applied against the upstream filter and selection table 324 using addresses of the packet 308 to determine whether they match the table 324. The table 324 primarily determines whether the packet 308 is to be forwarded in the context of a service chain, and determines whether filters, such as ACLs, are to be applied. The packet 308 is forwarded based on a subscriber identifier, such as the source IP address of the packet 308, as well as on the previous hop in the service chain in question, such as the source MAC address or the source MAC address and the VLAN of the packet 308.

In one implementation, if the packet 308 matches the upstream filter and selection table 324—that is, there is an entry or rule in the table 324 that matches the data packet 308—there are three possible outcomes. First, a combination of the subscriber identifier of the packet 308 and the previous hop of the packet 308 means that the next hop of the packet 308 is determined without further filtering or destination-based forwarding. As such, the next hop of the packet 308 can be deduced without having to apply any other upstream table 322 to the packet 308, and the packet 308 is forwarded to an indirection table to determine the NF to which the next hop corresponds (330). The destination MAC address of the packet 308 may be replaced with a virtual address corresponding to an index of the indirection table, so that the indirection table is able to specify an NF instance of the next hop.

Second, a combination of the subscriber identifier of the packet 308 and the previous hop of the packet 308 means that the next hop of the packet 308 is determined with additional filtering. As such, the next hop of the packet 308 is determined by sending to the packet to one of the upstream filter tables 326 as specified by the rule or entry of the upstream filter and selection table 324 that the packet 308 matches (334). In this case, the packet 308 has an NF determined for it to which the next hop corresponds just if further filtering, as provided by one or more of the upstream filter tables 326, indicates that there is such an NF. Further, a sub-table identifier meta-data field of the packet 308 is set, which is used for classification purposes by subsequent tables 326. This identifier serves as a sub-table identifier in effect, used to logically partition the tables 326 into multiple logical tables to define a limited number of actual OpenFlow tables 326 while functioning as if there were many more.

Third, a combination of the subscriber identifier of the packet 308 and the previous hop of the packet 308 means that the next hop of the packet 308 is determined via destination-based forwarding. As such, the next hop of the packet 308 is determined by sending the packet 308 to a destination-based forwarding table (332), similar to the arrow 318 of FIG. 3A. For example, the packet 308 may have an IP address belonging to a domain that is to be forwarded outside the scope of a service chain.

If the packet 308 does not match any rule or entry of the upstream filter and selection table 324, then a default rule of the table 324 is used to determine the next hop of the packet 308. In one implementation, the default rule is to further filter the data packet 308, by sending the packet 308 to one of the upstream filter tables (334). In another implementation, the default rule is for no further filtering of the data packet 308 to occur, in which case the packet 308 is sent to the filter-based upstream next hop table 328 (337) and bypassing the upstream filter tables 326 entirely. However, because the table 328 is a filter-based table, a default filter is effectively applied to the packet 308 first, such as by setting a metadata filter identifier sub-field of the packet 308 to indicate a default filter selection outcome and a metadata service chain path identifier sub-field to define a default service chain.

The upstream filter tables 326 operate as follows. For a given service chain, there may be up to a predetermined number of different filters, such as sixteen filters, to which the tables 326 correspond. Further, the filters correspond to NFs (i.e., NF groups or NF types, and not particular instances thereof), and thus effectively filter which packets are to be sent to those NFs. As such, each filter, and thus each upstream filter table 326, determines whether a packet should be sent to a network function to which the filter and table 326 in question correspond. In one implementation, if a packet is not to be sent to a given NF, further lookups in additional filter tables 326 may be performed to determine if the packet should be sent to subsequent network NF(s) in the service chain. This permits skipping NFs without unnecessary packet forwarding.

As an example, a given service chain may be defined as a series of four NFs. Each NF has an associated filter, implemented as an ACL. The ACLs thus are mapped to and therefore correspond to the upstream filter tables 326. The mapping may be achieved so that the number of match types per table 326 is minimized, rendering unnecessary the use of successive tables 326 as much as possible. As noted above, the ACLs may be black lists or white lists, or combinations thereof.

In one implementation, to permit multiple service chains to share the same upstream filter tables 326, the tables 326 are each logically partitioned by adding to a rule match a sub-table identifier that the upstream filter and selection table 324 or an earlier upstream filter table 326 may have set. At least two match types may be used in filter tables, one for the actual ACL rules, and another that acts as a default rule. Each rule of each table 326 can set a filter identifier sub-field within a packet to indicate the result of applying its filter against the packet, which assists the filter-based upstream next hop table 328 in determining the next hop of the packet.

Therefore, the upstream filter and selection table 324 selects one of the upstream filter tables 326 against which the packet 308 is applied. The data packet 308 is applied against this upstream filter table 326—via application against the ACL of the table 326 in question—to determine whether the NF to which the table 326 corresponds is applicable to the packet 308, or whether the packet 308 is to be sent to another filter table 326. In the latter case, the data packet 308 is forwarded to another upstream filter table 326 (336), via an OpenFlow protocol-defined “goto” action, which performs the same process. When an upstream filter table 326 determines that the data packet 308 is to be subjected to its NF, this information is added to the packet 308 by setting a metadata filter identifier sub-field of the packet 308 to indicate the table 326 in question, and the data packet 308 is forwarded to the filter-based upstream next hop table 328 (338).

The upstream filter tables 326 are thus particularly innovative. The tables 326 are subscriber and hop independent. Their size is thus unaffected by the number of subscribers or the number of NFs. The result of the filtering is appended with service chain hop and specific subscriber instead by the filter-based upstream next hop table 328. As such, the same tables 326 can be reused for each hop in a service chain, by skipping the tables 326 corresponding to NFs that a subscriber has already traversed.

The filtered data packet 308 is therefore applied against the filter-based next hop selection upstream table 328 to determine the next hop of the packet 308. It is noted that although the data packet 308 is technically filtered just if it arrives at the table 328 from the upstream filter tables 326 (338). However, because the data packet 308 has a default filter effectively applied to it if the packet 308 arrives directly from the upstream filter and selection table 324 (337), the data packet 308 can in this case still be referred as a filtered data packet.

Therefore, the data packet 308 arrives at the filter-based upstream next hop table 328 after one or more lookups within the upstream filter tables 326, or directly from the upstream filter and selection table 324. The table 328 can use different types of rules to specify the next hop of the packet 308. For example, a service chain path-based next hop selection rule may match the source MAC address of the packet 308 (indicating the previous NF in the service chain), the identification of the service chain path in question, and the metadata filter identifier sub-field (indicating the next hop NF type or group). In this way, the rule deterministically establishes to which next hop NF index the data packet 308 should be sent, where the NF index represents an NF instance and any standby instances of the same NF, as is described in relation to the indirection table. Further, the next hop NF index can be encoded within the packet 308 by replacing the destination MAC address, as is the case when the data packet is sent directly from the table 324 to the table 328. The data packet 308 is thus forwarded from the filter-based upstream next hop table 328 to the indirection table (330).

As another example, a subscriber-based next hop selection rule may match the source MAC address of the packet 308, and the source IP address of the packet 308 (indicating the subscriber), and the metadata filter identifier sub-field. This rule is similar to the prior rule, but substitutes the source IP address for the service chain path identification. This rule also dynamically determines the next hop NF index for the data packet 308, which is embedded within the packet 308 by replacing the destination MAC address with a virtual MAC address as noted above, and the packet 308 is forwarded from the filter-based upstream next hop table 328 to the indirection table (330) as well.

It is noted that the architecture of the upstream tables 322 is also such that advantageously a minimum number of the tables 322 are applied against the data packet 308. In some situations, just the upstream filter and selection table 324 is applied against the packet 308. In other situations, just two the table 324 and the filter-based upstream next hop table 328 are applied. In still other situations, besides the tables 324 and 328, a minimal number of the upstream filter tables 326 are applied, where the total number of the tables 326 is itself minimized since the tables 326 are subscriber and service chain independent. Therefore, the architecture of the upstream tables 322 minimizes both the total number of such tables 322, as well as the number thereof against which the data packet 308 is applied. This architecture helps ensure that packet processing quickly occurs within the OpenFlow switch of which the tables 322 are a part, permitting a greater number of packets to be processed by the switch in a minimum length of time. Additionally, because the tables 322 are subscriber-independent (i.e., a given service chain path over a set of NF instances can be common to a large number of scribers), the size of the tables 322 is relatively small compared to the number of subscribers. This ensures that the tables 322 fit into OpenFlow switches having relatively small amounts of memory, for instance.

FIG. 3C shows example downstream tables 342 that process the data packet 308 after the direction tables 300 of FIG. 3A have concluded that the packet 308 is part of a downstream service chain, per the arrow 312. The downstream tables 342 include a downstream filter and selection table 344 (in one implementation, OpenFlow table 22), multiple downstream filter tables 346 (in one implementation, OpenFlow tables 23-38), and a downstream next hop table 348 (in one implementation, OpenFlow table 40). In general, the packet 308 is applied against the downstream tables 342 such that the number of the tables 342 against which the packet 308 is applied is minimized, to determine the next hop of the packet 308. It is further noted that the downstream tables 342 are configured and operate similarly to the upstream tables 322 of FIG. 3B that have been described, and therefore the following description is provided in an abbreviated manner as compared to that of the upstream tables 322 to avoid redundancy.

The data packet 308 is first applied against the downstream filter and selection table 344 using addresses of the packet 308 to determine whether they match the table 344. In one implementation, if the packet 308 matches the downstream filter and selection table 344, there are three possible outcomes. First, a combination of a subscriber identifier of the packet 308 and the previous hop of the packet 308 means that the next hop is determined without further filtering or destination-based forwarding. The packet 308 is thus forwarded to an indirection table to determine the NF to which the next hop corresponds (350).

Second, a combination of the subscriber identifier of the packet 308 and the previous hop of the packet 308 means that the next hop of the packet 308 is determined with additional filtering. The next hop of the packet 308 is therefore determined by sending the packet to one of the downstream filter tables 346 as specified by the rule or entry of the downstream filter and selection table 344 that the packet 308 matches (354). Third, a combination of the subscriber identifier of the packet 308 and the previous hop of the packet 308 means that the next hop of the packet 308 is determined via destination-based forwarding. As such, the next hop of the packet 308 is determined by sending the packet 308 to a destination-based forwarding table (352).

If the packet 308 does not match any rule or entry of the downstream filter and selection table 344, then a default rule of the table 344 is used to determine the next hop of the packet 308. In one implementation, filtering is applied, and the packet 308 is sent to one of the downstream filter tables (354). In another implementation, no filtering is applied, and rather a default filter is effectively applied to the packet 308 and the packet 308 is then sent to the filter-based downstream next hop table 348 (357), bypassing the downstream filter tables 346 entirely.

The downstream filter tables 346 operate similar as to the upstream filter tables 326 of FIG. 3B. As such, the tables 346 correspond to different filters that correspond to NFs. The filter mays may be implemented as ACLs, which are thus mapped to and correspond to the downstream filter tables 346. The downstream filter and selection table 344 selects one of the downstream filter tables 346 against which the packet 308 is applied. The packet 308 is applied against this downstream filter table 346 to determine whether the NF to which the table 346 corresponds is applicable to the packet 308, or whether the packet 308 is to be sent to another filter table 346. In the latter case, the data packet 308 is forwarded to another downstream filter table 346 (356). When a downstream filter table 346 ultimately determines that the data packet 308 is to be subjected to its NF, this information is added to the packet 308, and the data packet 308 is forwarded to the filter-based downstream next hop table 348 (358).

The filtered data packet 308 is applied against the filter-based next hop selection downstream table 348 to determine the next hop of the packet 308. It is noted that although the data packet 308 is technically filtered just if it arrives at the table 348 from the downstream filter tables 346 (358). However, because the data packet 308 has a default filter effectively applied to it if the packet 308 arrives directly from the downstream filter and selection table 344 (357), the data packet 308 can in this case still be referred to as a filtered data packet.

The filter-based next hop selection downstream table 348 can use different types of rules to specify the next hop of the packet 308. A rule of the table deterministically establishes to which next hop NF index the packet 308 should be sent, where the NF index represents an NF instance and any standby instances of the same NF. This can be achieved by embedding the NF index within the destination MAC address of the packet 308, or via setting metadata of the packet 308. As such, the packet 308 is forwarded from the filter-based downstream next hop table 348 to the indirection table (350).

Like the upstream tables 322, the architecture of the downstream tables 342 is also such that advantageously a minimum number of the tables 342 are applied against the data packet 308. In some situations, just the downstream filter and selection table 344 is applied against the packet 308. In other situations, just two the table 344 and the filter-based downstream next hop table 348 are applied. In still other situations, besides the tables 344 and 348, a minimal number of the downstream filter tables 346 are applied, where the total number of the tables 346 is itself minimized since the tables 346 are subscriber and service chain independent. Therefore, the architecture of the downstream tables 342 minimizes both the total number of such tables 342, as well as the number thereof against which the data packet 308 is applied. This architecture helps ensure that packet processing quickly occurs within the OpenFlow switch of which the tables 342 are a part, permitting a greater number of packets to be processed by the switch in a minimum length of time.

FIG. 3D shows five additional example tables: a destination-based forwarding table 360 (in one implementation, OpenFlow table 50), an indirection table 362 (in one implementation, OpenFlow table 60), a mirror table 364 (in one implementation, OpenFlow table 90), a group table 366 (OpenFlow group table), and a tapping table 368 (in one implementation, OpenFlow table 70). The data packet 308 arrives at the destination-based forwarding table 360 from the direction selection table 302 of FIG. 3A (318), from the upstream filter and selection table 324 of FIG. 3B (332), or from the downstream filter and selection table 344 of FIG. 3C (352). The data packet 308 arrives at the indirection table 362 from the upstream filter and selection table 324 or the filter-based upstream next hop table 328 of FIG. 3B (330), or from the downstream filter and selection table 344 or the filter-based downstream next hop table 348 of FIG. 3C (350). In both of these situations, the data packet 308 originally arrived at an outerlay port to the direction selection table 302 of FIG. 3A, before ultimately arriving at the destination-based forwarding table 360 or the indirection table 362.

When the data packet 308 arrives at the destination-based forwarding table 360, the packet 308 is applied against the table 360 to determine the next hop of the packet 308. The data packet 308 arrives at the destination-based forwarding table 360 because forwarding is to be performed based on the destination address present within the packet 308, such as within a context of a virtual routing forwarding (VRF) table identified by a metadata sub-field VRFID set by the rule of the table that forwarded the packet 308 to the table 360. In one implementation, there may three different types of rule matches within the table 360.

First, the destination-based forwarding table 360 may match a destination MAC address, or a combination of the destination MAC address and the VRFID, to select the next hop of the packet 308. In this sense, the table 360 can be considered as being equivalent to a MAC table for layer two (L2) forwarding. The default rule may be linked to flooding or packet dropping.

Second, the destination-based forwarding table 360 may match a destination IP address and/or subnet, or a combination of the destination IP address and/or subnet and the VRFID, to select the next hop of the packet 308. In this sense, the table 360 can be considered as being equivalent to an IP forwarding table selecting a best match IP subnet for forwarding network traffic. The default rule may be set to forward traffic to a default gateway, for instance, or to drop packets.

Third, the destination-based forwarding table 360 may, as a least priority rule if no other rules of the table 360 match the packet 308, match the VRFID of the packet 308, on a per-VRFID basis. This permits multiple VRFs to be mixed. As such, the VRFs can refer to the same L2 or layer three (L3) address within the table 360. In each of these three cases, the destination-based forwarding table 360 then forwards the packet 308 to the group table 366 (372), for actual forwarding or routing from the OpenFlow switch.

When the data packet 308 arrives at the indirection table 362, the packet 308 is applied against the table 362 to specify an NF instance of the next hop of the packet 308. The packet 308 arrives at the table 362 by a referring rule of a referring table that replaced the destination MAC address of the packet 308 with a virtual MAC address referencing an index of the table 362. The table 362 thus provides an indirection between a next hop selection in the preceding table and the actual selection of an NF instance to which to forward the packet 308.

The indirection provided by the indirection table 362 permits updating the next hop as desired without having to update a large number of rules of tables that forward the packet 308 to the table 362, such as the upstream filter tables 326 of FIG. 3B and the downstream filter tables 346 of FIG. 3C. Updating may be performed, for example, when a particular NF instance has failed. Additionally, even when the NF instances are operating without failure, the indirection can permit network traffic diversion to alternate NF instances as desired.

The virtual MAC address of the data packet 308 thus acts as an index to the table 362. The rules of the indirection table 362 replace the virtual MAC address with the MAC address of the actual NF interface that is to be selected, which is referred to as destination indirection. In another implementation, rather than employing a virtual MAC address, a metadata register may instead be used to reference an index within the table 362. Once the MAC address of the actual NF interface has been selected and has been added to the packet 308, the indirection table 362 forwards the packet 308 to the group table 366 (372).

The architecture of the indirection table 362 vis-à-vis the architecture of the upstream filter tables 326 of FIG. 3B and the downstream filter tables 346 of FIG. 3C thus provide for added robustness and ease of updating of the actual NF instances to which data packets are forwarded. That is, rather than programming the identities of these NF instances directly within the tables 326 and 346, just in effect an indices to NF instances are programmed within the tables 326 and 346. The mapping of the indices to the actual NF instances is programmed within a single table, the indirection table 362. Therefore, when failover has to occur among instances of the same NF, or when updating how traffic is to be forwarded among different NF instances has to be performed, just the indirection table 362 has to be updated, without having to update the tables 326 and 346.

When the data packet 308 arrives at the group table 366 from the destination-based forwarding table 360 or the indirection table 362 (372), the packet 308 is applied against the table 366 to select an actual network path towards the NF instance of the next hop of the packet 308 that the table 362 has selected, or the actual network path towards the destination that the table 360 has selected. The group table 366 differs from the other tables in that it is not a lookup table that matches packet fields. Rather, the group table 366 includes group entries, that each include a list of actions with semantics dependent on the type of group in question. The actions in each list are then applied to the data packets.

One group type is “all,” for multicasting the same packet to multiple destinations by invoking all the entries within the group table 366. A second group type is “select,” which for load balancing and other purposes selects one of the lists of actions to invoke. A third group type is “fast failover,” which for high availability and other purposes selects one of the lists of actions to invoke based on a livelihood indication per list. A fourth group type is “indirect,” which refers to just one list of actions.

As such, although the indirection table 362 selects the actual NF instance, and the destination-based forwarding table 360 selects the actual destination, of the next hop of the packet 308, it is the group table 366 that selects the actual network path towards this NF instance or destination. The group table 366 may, for instance, select a particular output port of the OpenFlow switch. In turn, this output port may be mapped to a physical or virtual switch port, or to a tunnel traversing the underlay network 114. Therefore, after application against the group table 366, the data packet 308 is forwarded or routed to the next hop along the network path selected by the table 366 (374).

In some implementations, the mirror table 364 and/or the tapping table 368 can be included, in which case the data packet 308 is applied against these tables 364 and 368 prior to being applied against the table 366 (376, 378). The mirror table 364 mirrors matching data packets. As such, if the data packet 308 matches a rule of the table 364, the data packet 308 is duplicated or copied, looped back using an OpenFlow packet-out command via a loopback interface, and matched using the tables that have been described so that this copy is sent to a different destination (i.e., a different next hop) than the packet 308 is. For example, the copy may be sent to an analytics NF for generating statistical information regarding network traffic.

The tapping table 368 similarly replicates matching data packets. As such, if the data packet 308 matches a rule of the tapping table 368, the data packet is replicated, and this replicate is sent to a different destination than the packet 308 is. For example, the replicate may be sent to a different destination (i.e., a different next hop) for traffic monitoring purposes. One difference between the mirror table 364 and the tapping table 368 can be that the former sends its copy of packet 308 to an NF instance, whereas the latter sends its copy of the packet 308 to a destination other than an NF instance. Another difference can be that packets sent via the tapping table 368 are transmitted to a dedicated tapping VNF over a tunnel that preserves L2 information, whereas packets sent via the mirror table 308 are forwarded to a mirror NF in an unencapsulated manner like to any other NF. The mirror tables 308 can further act as an indirection table for mirrored packets.

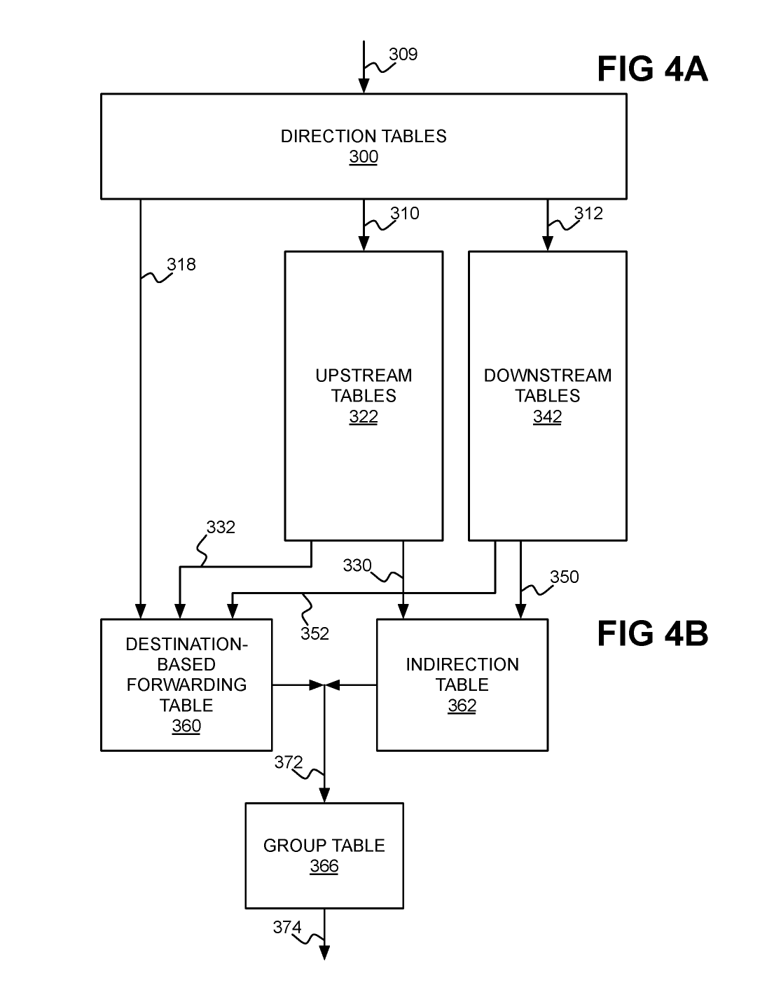

FIGS. 4A and 4B show the example tables of FIGS. 3A, 3B, 3C, and 3D in an overall manner. FIG. 4A includes the direction tables 300, the upstream tables 322, and the downstream tables 342. FIG. 4B includes the destination-based forwarding table 360, the indirection table 362, and the group table 366.

Data packets are first applied against the direction tables 300 (309). Based on the results of this application, the data packets can be routed or forwarded to the destination-based forwarding table 360 (318), the upstream tables 322 (310), or the downstream tables 342 (312). The packets applied against the upstream tables 322 are then routed or forwarded to the destination-based forwarding table 360 (332) or the indirection table 362 (330). Similarly, the packets applied against the downstream tables 342 are then routed or forwarded to the destination-based forwarding table 360 (352) or the indirection table 362 (350). The packets applied against the destination-based forwarding table 360 are routed or forwarded to the group table 366, as are the packets applied against the indirection table 362 (372). The group table 366 is applied against a packet to determine the actual network path that the packet should take in being forwarded or routed, and then the packet is forwarded or routed to its next hop along this path (374).

Data packets that pertain to service chains are thus applied against the direction tables 309, the upstream tables 322 or the downstream tables 342, the indirection table 362, and the group table 366. Such packets are forwarded or routed to next hops that are NF instances, along network paths. Data packets that do not pertain to service chains are applied against the direction tables 309, the destination-based forwarding table 360, and the group table 366, or against the direction tables 309, the upstream tables 322 or the downstream tables 342, the destination-based forwarding table 360, and the group table 366. Such packets are forwarded or routed to next hops based on the destination addresses indicated by the packets along network paths.

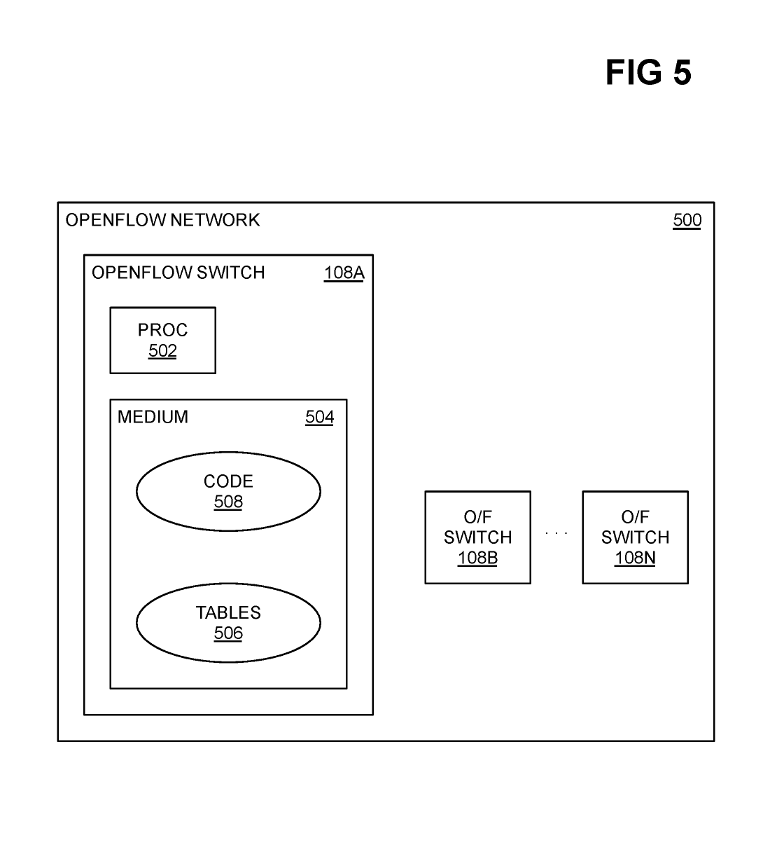

FIG. 5 shows an example OpenFlow network 500, including specifically OpenFlow switches 108A, 108B, . . . , 108N, which are collectively referred to as the OpenFlow switches 108. The OpenFlow controllers 106 of FIG. 1, and other components of an OpenFlow network, are not shown for illustrative clarity and convenience. That is, from the perspective of data packet routing within the OpenFlow network 500, the components that actually forward or route the data packets are at least primarily the OpenFlow switches 108.

The OpenFlow switch 108A is depicted in detail as representative of each of the OpenFlow switches 108. The OpenFlow switch 108A may be implemented in software running on hardware, or on hardware directly. Therefore, it can be said that the OpenFlow switch 108A includes at least a hardware processor 502 and a non-transitory computer-readable data storage medium 504. The medium 504 stores tables 506, which include the tables of FIGS. 3A-3D and 4 that have been described in detail, against which data packets are applied to determine their next hops for routing through the OpenFlow network 500. The medium 504 further stores computer-executable code 508 that the processor 502 executes to actually apply the data packets against the tables 506, to forward the data packets among the tables 506, to receive the packets at the switch 108A, and to route the packets from the switch 108A.

The techniques disclosed herein thus provide for a novel manner by which OpenFlow switches can be programmed to realize efficient processing of packets through an OpenFlow network made up of such switches. This manner in particular permits the ability of data packets to be forwarded or routed along service chains made up of different NFs. Specifically, the OpenFlow switches are each programmed with multiple tables. A given packet, however, is applied against a minimal number of these tables to determine the packet's next hop. Furthermore, the upstream and downstream tables for service chain-oriented packets do not actually have to specify the instances of the NFs of the next hops of these packets, but rather just specify indices of an indirection table that itself is used to specify the NF instances.

We claim:

1. A method comprising:
receiving, by an OpenFlow switch, a data packet to be routed to a next hop corresponding to a network function;
applying, by the switch, the packet against one or more direction tables to determine whether the packet is part of an upstream service chain, part of a downstream service chain, or is to be forwarded in a destination-based manner;
in response to determining that the packet is part of the upstream service chain, applying, by the switch, the packet against a plurality of upstream tables to determine the next hop;
in response to determining that the packet is part of the downstream service chain, applying, by the switch, the packet against a plurality of downstream tables to determine the next hop; and
routing, by the switch, the packet to the next hop.

2. The method of claim 1, wherein in applying the packet against the upstream tables, the switch applies the packet against the upstream tables in a manner so that a number of the upstream tables against which the packet is applied is minimized,
and wherein in applying the packet against the downstream tables, the switch applies the packet against the downstream tables in a manner so that a number of the downstream tables against which the packet is applied is minimized.

3. The method of claim 1, wherein applying the packet against the upstream tables or the downstream tables results in specification of an index that corresponds to a network function instance of the next hop, without actually specifying the network function instance.

4. The method of claim 3, further comprising, after applying the packet against the upstream tables or the downstream tables:
applying, by the switch, the packet against the indirection table to specify a network function interface instance of the next hop from the specification of the index; and
applying, by the switch, the packet against a group table to select a network path towards the network function instance of the next hop,
wherein routing the packet to the next hop comprises routing the packet to the network function instance of the next hop via the network path.

5. The method of claim 1, wherein applying the packet against the one or more direction tables comprises:
if the packet includes a type indicating that the packet is an Internet Protocol (IP) packet:
applying the packet against a first direction table using a source address of the packet, to yield one of:
the source address of the packet is known, and whether the packet is part of the upstream service chain or the downstream service chain is determinable;
the source address of the packet is known, but whether the packet is part of the upstream service chain or the downstream service chain is indeterminable;
the source address of the packet is unknown;
if the source address of the packet is known but whether the packet is part of the upstream service chain or the downstream service chain is indeterminable, applying the packet against a second direction table to use a part of the packet other than the source address to determine whether the packet is part of the upstream service chain or the downstream service chain.

6. The method of claim 1, wherein applying the packet against the upstream tables comprises:
applying the packet against a first upstream table using a plurality of addresses of the packet to determine whether the addresses of the packet match the first upstream table;
in response to determining that the addresses of the packet match the first upstream table, using the table to determine the next hop based on one of:
a combination of a subscriber identifier of the packet and a previous hop of the packet with no further filtering or destination-based forwarding;
a combination of the subscriber identifier of the packet and the previous hop of the packet with further filtering;
a combination of the subscriber identifier of the packet and the previous hop of the packet with destination-based forwarding;
in response to determining that the addresses of the packet do not match the first upstream table, using a default rule of the table to determine the next hop.

7. The method of claim 6, wherein applying the packet against the upstream tables further comprises:
where using the table to determine the next hop is based on the combination of the subscribe identifier of the packet and the previous hop of the packet with no further filtering or destination-based forwarding,
replacing a destination address of the packet with a virtual address corresponding to an index of an indirection table that is not one of the upstream tables, and forwarding the packet to the indirection table to specify a network function interface instance of the next hop;
where using the table to determine the next hop is based on the combination of the subscriber identifier of the packet and the previous hop of the packet with further filtering,
applying the packet against one of the upstream tables, other than the first upstream table, as specified by the first upstream table, to filter the packet against an access control list (ACL) of the one of the upstream tables, and applying the filtered packet against a filter-based next hop selection upstream table of the upstream tables to determine the next hop;
where using the table to determine the next hop is based on the combination of the subscriber identifier of the packet of the packet and the previous hop of the packet with destination-based forwarding,
forwarding the packet to a destination-based forwarding table to determine the next hop.

8. The method of claim 6, wherein using the default rule of the table to determine the next hop comprises one of:
using the default rule of the table with filters, such that the packet is applied against one of the upstream tables, other than the first upstream table, to filter the packet against an access control list (ACL) of the one of the upstream tables, and then apply the filtered packet against a filter-based next hop selection upstream table of the upstream tables to determine the next hop;
using the default rule of the table without filters, to provide a default filter to the packet and then apply the default-filtered packet against the filter-based next hop selection upstream table to determine the next hop.

9. The method of claim 1, wherein applying the packet against the downstream tables comprises:
applying the packet against a first downstream table using a plurality of addresses of the packet to determine whether the addresses of the packet match the first downstream table;
in response to determining that the addresses of the packet match the first downstream table, using the table to determine the next hop based on one of:
a combination of a subscriber identifier of the packet and a previous hop of the packet with no further filtering or destination-based forwarding;
a combination of the subscriber identifier of the packet and the previous hop of the packet with further filtering;
a combination of the subscriber identifier of the packet and the previous hop of the packet with destination-based forwarding;
in response to determining that the addresses of the packet do not match the first downstream table, using a default rule of the table to determine the next hop.

10. The method of claim 9, wherein applying the packet against the downstream tables further comprises:
where using the table to determine the next hop is based on the combination of the subscribe identifier of the packet and the previous hop of the packet with no further filtering or destination-based forwarding,
replacing a destination address of the packet with a virtual address corresponding to an index of an indirection table that is not one of the downstream tables, and forwarding the packet to the indirection table to specify a network function interface instance of the next hop;
where using the table to determine the next hop is based on the combination of the subscriber identifier of the packet and the previous hop of the packet with further filtering,
applying the packet against one of the downstream tables, other than the first downstream table, as specified by the first downstream table, to filter the packet against an access control list (ACL) of the one of the downstream tables, and applying the filtered packet against a filter-based next hop selection downstream table of the downstream tables to determine the next hop;
where using the table to determine the next hop is based on the combination of the subscriber identifier of the packet of the packet and the previous hop of the packet with destination-based forwarding,
forwarding the packet to a destination-based forwarding table to determine the next hop.

11. The method of claim 9, wherein using the default rule of the table to determine the next hop comprises one of:
using the default rule of the table with filters, such that the packet is applied against one of the downstream tables, other than the first downstream table, to filter the packet against an access control list (ACL) of the one of the downstream tables, and then apply the filtered packet against a filter-based next hop selection downstream table of the downstream tables to determine the next hop;
using the default rule of the table without filters, to provide a default filter to the packet and then apply the default-filtered packet against the filter-based next hop selection downstream table to determine the next hop.

12. The method of claim 1, further comprising:
in response to determining that the packet is to be forwarded in the destination-based manner, applying the packet against a destination-based forwarding table to determine the next hop.

13. A non-transitory computer-readable data storage medium storing computer-executable code executable by an OpenFlow switch to route a data packet to a next hop corresponding to a network function by minimally applying the data packet against a plurality of tables comprising:
one or more direction tables to determine whether the packet is part of an upstream service chain, part of a downstream service chain, or is to be forwarded in a destination-based manner;
one or more upstream tables to determine the next hop of the packet when the packet is part of the upstream service chain; and
one or more downstream tables to determine the next hop of the packet when the packet is part of the downstream service chain.

14. A system comprising:
an OpenFlow network; and
a plurality of OpenFlow switches of the OpenFlow network, each OpenFlow switch programmed with a plurality of flow tables to forward data packets to next hops in accordance with service chains by applying the data packets against a minimal number of the flow tables.
